(19) United States
(12) Patent Application Publication
(10) Pub. No.: US 2005/0132648 A1
(43) Pub. Date: Jun. 23, 2005

(54) Fuel reformer housing container and fuel reforming apparatus

(75) Inventors: Masaaki Miyahara, Kokubu-shi (JP); Yoshihiro Basho, Kokubu-shi (JP); Ryuji Mori, Kokubu-shi (JP); Toshihiro Hashimoto, Kokubu-shi (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 10/999,377

(22) Filed: Nov. 29, 2004

(30) Foreign Application Priority Data
Nov. 27, 2003 (JP) P2003-396925
Nov. 27, 2003 (JP) P2003-396926
Jan. 28, 2004 (JP) P2004-20280
Jan. 28, 2004 (JP) P2004-20281

(51) Int. Cl. C10J 1/00

(52) U.S. Cl. 48/127.9; 48/61

(57) ABSTRACT

A fuel reformer housing container includes a base, a lid, a supply pipe and a discharge pipe. The base has on an upper surface thereof a concave portion for housing a fuel reformer for generating reformed gas including hydrogen gas from fuel therein. The lid is attached to the upper surface of the base to cover the concave portion. The supply pipe supplies fuel to the fuel reformer, pierces the concave portion so that a front end thereof is joined to the fuel reformer, and holds the fuel reformer in a space between the lid and the concave portion. The discharge pipe discharges reformed gas and pierces the concave portion so that a front end thereof is joined to the fuel reformer, and holds the fuel reformer in the space between the lid and the concave portion.

### BACKGROUND OF THE INVENTION

1. Field of the Invention

The present invention relates to a fuel reformer housing container for constituting a fuel reforming apparatus using a fuel reformer that generates hydrogen gas from all sorts of fuels by utilizing a steam reforming reaction which is an endothermic catalytic reaction, in, for example, a fuel cell system, and also relates to the fuel reforming apparatus.

2. Description of the Related Art

In recent years, a fuel cell system has been in the limelight as a next-generation power source system that produces electric energy efficiently and cleanly, and in an automobile market and a market of a cogeneration power generation system typified by a household fuel cell power generation system, field tests for practical implementation aiming at cost reduction have been executed energetically already.

Besides, it has been examined recently to miniaturize the fuel cell system and use as a power source of mobile equipment such as a mobile phone, a PDA (personal digital assistant), a notebook computer, a digital video camera and a digital still camera.

Generally, in a fuel cell, hydrocarbon gas such as methane and natural gas (CNG) or alcohol such as methanol and ethanol is used as fuel, and power generation is performed by reforming to hydrogen gas and another gas by a steam reforming reaction in a fuel reforming apparatus using a fuel reformer and thereafter supplying the hydrogen gas to a power generation apparatus referred to as a power generation cell.

In this case, reforming of fuel by the fuel reformer is a process of bonding a reformable fuel to steam and generating hydrogen gas by a catalytic reaction.

For example, in the case of using methanol as fuel, it is a process of generating hydrogen gas (H₂) by a steam reforming reaction as expressed by the following chemical equation (1) (a reaction of bonding steam to methanol and thereby reforming methanol to hydrogen and carbon dioxide in the equation (1)). A minute amount of generated gas (mainly CO₂) other than hydrogen generated by the reforming reaction is discharged into the air usually.
CH₃OH+H₂O→3H₂+CO₂ (1)

Further, since the steam reforming reaction is an endothermic reaction, it is necessary to heat fuel with a heater or the like from outside and maintain a reaction temperature. Therefore, for reforming fuel in the fuel reformer, in order to prevent steam reforming activity of a catalyst from lowering and keep the density of produced hydrogen gas high, temperatures of approximately 200 to 500° C. are required in the case of using methanol as fuel, and temperatures as high as approximately 300 to 800° C. are required in the case of using methane gas, for example.

Then, in the cogeneration power generation system typified by the household fuel cell system, the system itself is large in size, and therefore, an external wall of a fuel reformer housing container has a double structure to form a vacuum container, or a heat insulating material is filled in between internal and external walls having the double structure, whereby it is prevented that heat inside the fuel reformer is conducted to the outside and the temperature of the fuel reformer is lowered. Accordingly, at the time of housing the fuel reformer in the fuel reformer housing container, it is possible to directly join the fuel reformer to the internal wall of the double structure of the fuel reformer housing container and securely place. As a related art, there is Japanese Unexamined Patent Publication JP-A 2003-2602.

However, the fuel cell system for mobile equipment is requested to be small in size and low in height so as to be housed in the mobile equipment. On the other hand, making the external wall of the fuel reformer housing container to have a double-structure as ever cannot be adopted in the fuel cell system for mobile equipment, because the whole fuel cell system becomes complicated and large in size. Besides, in the case of directly joining the fuel reformer to the internal wall of the double structure of the fuel reformer housing container and securely placing, heat of the fuel reformer is directly conducted to the fuel reformer housing container through a joined region. As a result, the temperature of the surface of the fuel reformer housing container rises, so that there is a danger that the heat breaks other components in the mobile equipment and burns a user of the mobile equipment.

Further, since the steam reforming reaction as expressed by the chemical equation (1) is an endothermic reaction, it is necessary for reforming fuel in the fuel reformer to heat the fuel reformer with a heater or the like and thereby keep a reaction temperature at a fixed temperature. However, when heat generated in the fuel reformer is conducted to the fuel reformer housing container, the temperature of the fuel reformer thereby lowers. Then, in order to maintain the reaction temperature, it is necessary to increase the amount of power generation of the heater. In a case where the amount of power generation of the heater is increased, there arises a problem that electric capacity used for heating the heater occupying in the total electric capacity generated in the power generation cell of the fuel cell increases, and that power generation loss in the whole fuel cell system increases as a result.

### SUMMARY OF THE INVENTION

The invention has been completed in consideration of the problems in the related art, and an object thereof is to provide a fuel reformer housing container that is capable of favorably supplying fuel to a fuel reformer and safely discharging gas such as hydrogen gas obtained by reforming in the fuel reformer to the outside of the fuel reformer housing container and in which power generation loss is small, and also provide a fuel reforming apparatus.

The invention provides a fuel reformer housing container comprising:
a base having on one surface thereof a concave portion for housing a fuel reformer for generating reformed gas including hydrogen gas from fuel therein;
a lid attached to the one surface of the base so as to cover the concave portion;
a supply pipe for supplying fuel to the fuel reformer, the supply pipe piercing at least one of the base and the lid so that a front end thereof is joined to the fuel reformer, and holding the fuel reformer in a space between the lid and a bottom surface of the concave portion; and
a discharge pipe for discharging the reformed gas, the discharge pipe piercing at least one of the base and the lid so that a front end thereof is joined to the fuel reformer, and holding the fuel reformer in a space between the lid and the bottom surface of the concave portion.

In the invention, thermal conductivities of the supply pipe and the discharge pipe are 120 W/m·K or less.

In the invention, the discharge pipe has an opening area larger than an opening area of a discharge hole of the fuel reformer.

In the invention, the supply pipe and the discharge pipe are formed so that cross sections of joining portions to the fuel reformer are smaller than cross sections of regions other than the joining portions.

In the invention, the supply pipe and the discharge pipe are joined to the fuel reformer via members that are joined to the front ends thereof with a joining material and have larger outer diameters than the supply pipe and the discharge pipe.

In the invention, the supply pipe and the discharge pipe are joined to the fuel reformer via the members by anodic bonding.

In the invention, thermal conductivities of the supply pipe and the discharge pipe are 120 W/m·K or less.

In the invention, the discharge pipe has an opening area larger than an opening area of a discharge hole of the fuel reformer.

In the invention, the supply pipe and the discharge pipe are formed so that cross sections of joining portions to the members and cross sections of joining portions to the fuel reformer are smaller than cross sections of regions other than the respective joining portions.

In the invention, an absolute value of a difference in thermal expansion coefficients between the member and the fuel reformer is 20×10⁻⁶/° C. or less.

The invention provides a fuel reforming apparatus comprising:
the fuel reformer housing container mentioned above; and
a fuel reformer installed in the concave portion.

The invention provides a fuel reforming apparatus comprising:
a fuel reformer for generating reformed gas including hydrogen gas from fuel;
a base having on one surface thereof a concave portion for housing the fuel reformer therein;
a lid attached to the one surface of the base so as to cover the concave portion;
a supply pipe for supplying fuel to the fuel reformer, the supply pipe piercing at least one of the base and the lid so that a front end thereof is joined to the fuel reformer, and holding the fuel reformer in a space between the lid and a bottom surface of the concave portion; and
a discharge pipe for discharging the reformed gas, the discharge pipe piercing at least one of the base and the lid so that a front end thereof is joined to the fuel reformer, and holding the fuel reformer in a space between the lid and the bottom surface of the concave portion,
wherein the fuel reformer is formed so that a plate-shaped member that is provided with through holes communicating with the supply pipe and the discharge pipe and forms part of the fuel reformer is joined to a rest part of the fuel reformer.

In the invention, the plate-shaped member is joined to the rest part of the fuel reformer by anodic bonding.

In the invention, an absolute value of a difference in thermal expansion coefficients between the plate-shaped member and the rest part of the fuel reformer is 20×10⁻⁶/° C. or less.

The invention provides a fuel reforming apparatus comprising:
a fuel reformer for generating reformed gas including hydrogen gas from fuel;
a base that has on one surface thereof a concave portion for housing the fuel reformer therein;
a lid attached to the one surface of the base so as to cover the concave portion; and
a pipe-shaped member whose central portion is parallel to a bottom surface of the concave portion in a space between the lid and the bottom surface of the concave portion and both end portions pierce the base or the lid, respectively, and in which fuel is supplied from one of the end portions and the reformed gas is discharged from the other end portion,
wherein the pipe-shaped member is cut and removed in parallel to an axial direction at an upper side of the central portion and forms part of the fuel reformer, and the fuel reformer is composed so that a rest part of the fuel reformer is joined onto a lower side of the central portion of the pipe-shaped member.

In the invention, the pipe-shaped member is joined to the rest part of the fuel reformer by anodic bonding.

In the invention, an absolute value of a difference in thermal expansion coefficients between the plate-shaped member and the rest part of the fuel reformer is 20×10⁻⁶/° C. or less.

According to the invention, the fuel reformer housing container comprises a base having on one surface thereof a concave portion for housing a fuel reformer for generating reformed gas including hydrogen gas from fuel therein; a lid attached to the one surface of the base so as to cover the concave portion; a supply pipe for supplying fuel to the fuel reformer, the supply pipe piercing at least one of the base and the lid so that a front end thereof is joined to the fuel reformer, and holding the fuel reformer in a space between the lid and a bottom surface of the concave portion; and a discharge pipe for discharging the reformed gas, the discharge pipe piercing at least one of the base and the lid so that a front end thereof is joined to the fuel reformer, and holding the fuel reformer in a space between the lid and the bottom surface of the concave portion. Therefore, it is not necessary to directly join the whole rear surface of the fuel reformer to the inside of the base and the lid by surface junction, or join via a pedestal or the like, and it is possible to effectively restrain heat of the fuel reformer from being conducted to the base and the lid. As a result, it is possible to thermally insulate the fuel reformer and restrain the temperature of the fuel reformer from decreasing, it is not necessary to keep supplying a large amount of electric power to a heater for maintaining a temperature necessary for favorably operating the fuel reformer, and it is possible to outstandingly increase the efficiency of power generation.

Further, since it is possible to largely reduce thermal conduction from the fuel reformer to the base and the lid, it becomes possible to effectively restrain the temperature of an external wall surface of the fuel reformer housing container from rising. As a result, it is possible to effectively prevent that other components in mobile equipment are broken and a user of the mobile equipment is burnt.

According to the invention, the thermal conductivities of the supply pipe and the discharge pipe are 120 W/m·K or less. Therefore, it is possible to more effectively reduce heat conducted from the fuel reformer to the base and the lid via the supply pipe and the discharge pipe, and it is possible to more effectively restrain the temperature of the fuel reformer from decreasing and restrain the temperature of the fuel reformer housing container from rising.

According to the invention, the opening area of the discharge pipe is larger than the opening area of the discharge hole of the fuel reformer. Therefore, it is possible to make resistance of flowing of reformed gas from the fuel reformer to the discharge pipe small, and it is possible to smooth discharge of reformed gas from the fuel reformer and largely increase the efficiency of fuel reforming.

According to the invention, the supply pipe and the discharge pipe are formed so that the cross sections of joining portions to the fuel reformer are smaller than the cross sections of regions other than the joining portions. Therefore, it is possible to favorably maintain the joining strength of the supply pipe and the discharge pipe to the fuel reformer, and more effectively restrain heat from the fuel reformer from being conducted to the base and the lid.

Further, the supply pipe and the discharge pipe are capable of moderately transforming them in the regions having small cross sections. As a result, in a case where stress due to a difference in thermal expansion coefficients is caused among the supply pipe, the discharge pipe, the fuel reformer, the base and the lid, and in a case where a shock or the like from outside is applied to the fuel reformer housing container, it is possible to relieve the stress by proper transformation of the supply pipe and the discharge pipe, and it is possible to favorably maintain junction of the joining portions of the supply pipe and the discharge pipe to the fuel reformer.

According to the invention, since the supply pipe and the discharge pipe are joined, preferably by anodic bonding, to the fuel reformer via the members that are joined to the front ends thereof with a joining material and have larger outer diameters than the supply pipe and the discharge pipe, it is possible to make the junction area of the member and the fuel reformer large and increase the joining strength thereof. Further, by the joining material for joining the member and the supply pipe as well as the member and the discharge pipe, it is possible to effectively relieve stress resulting from a difference in thermal expansion coefficients caused among the fuel reformer, the members, the supply pipe and the discharge pipe, and stress resulting from vibrations caused by fuel supply, discharge of reformed gas and so on and a shock from outside. Accordingly, it is possible to make reliability in junction of the fuel reformer to the supply pipe and the discharge pipe remarkably high.

Further, since the member is joined by anodic bonding to the fuel reformer without using a joining material, it is possible to reduce a junction height, and consequently, it is possible to reduce the height of the fuel reformer housing container, with the result that it is possible to reduce the height of mobile equipment itself.

Furthermore, since a brazing material having high thermal conductivity or the like is not used as a joining material, and the member and the fuel reformer are directly joined by anodic bonding, it is possible to more effectively restrain heat from the fuel reformer from being conducted to the base and the lid.

According to the invention, the supply pipe and the discharge pipe are formed so that the cross sections of joining portions to the members and the cross sections of joining portions to the fuel reformer are smaller than the cross sections of regions other than the respective joining portions. Therefore, it is possible to favorably maintain the joining strength of the supply pipe and the discharge pipe to the respective members and the joining strength of the supply pipe and the discharge pipe to the fuel reformer, and more effectively restrain heat from the fuel reformer from being conducted to the base and the lid.

Further, the supply pipe and the discharge pipe are capable of moderately transforming in the regions having small cross sections. As a result, in a case where stress due to a difference in thermal expansion coefficients is caused among the supply pipe, the discharge pipe, the fuel reformer, the base and the lid, and in a case where a shock or the like from outside is applied to the fuel reformer housing container, it is possible to relieve the stress by proper transformation of the supply pipe and the discharge pipe, and it is possible to favorably maintain junction of the joining portions of the supply pipe and the discharge pipe to the fuel reformer and junction of the joining portions of the supply pipe and the discharge pipe to the members.

According to the invention, the fuel reforming apparatus comprises the fuel reformer housing container of the invention, the fuel reformer installed in the concave portion. Therefore, it becomes a fuel reforming apparatus that is provided with the fuel reformer housing container of the invention and capable of safely discharging gas such as hydrogen gas obtained by reforming in the fuel reformer to the outside of the fuel reformer housing container and making power generation loss small.

According to the invention, the fuel reforming apparatus comprises a fuel reformer for generating reformed gas including hydrogen gas from fuel; a base having on one surface thereof a concave portion for housing the fuel reformer therein; a lid attached to the one surface of the base so as to cover the concave portion; a supply pipe for supplying fuel to the fuel reformer, the supply pipe piercing at least one of the base and the lid so that a front end thereof is joined to the fuel reformer, and holding the fuel reformer in a space between the lid and a bottom surface of the concave portion; and a discharge pipe for discharging the reformed gas, the discharge pipe piercing at least one of the base and the lid so that a front end thereof is joined to the fuel reformer, and holding the fuel reformer in a space between the lid and the bottom surface of the concave portion, wherein the fuel reformer is formed so that a plate-shaped member that is provided with through holes communicating with the supply pipe and the discharge pipe and forms part of the fuel reformer is joined to a rest part of the fuel reformer, preferably by anodic bonding. Therefore, it is not necessary to directly join the whole rear surface of the fuel reformer to the inside of the base and the lid by surface junction, or join via a pedestal or the like, and it is possible to effectively restrain heat of the fuel reformer from being conducted to the base and the lid. As a result, it is possible to thermally insulate the fuel reformer and restrain the temperature of the fuel reformer from decreasing, it is not necessary to keep supplying a large amount of electric power to a heater for maintaining a temperature necessary for favorably operating the fuel reformer, and it is possible to outstandingly increase the efficiency of power generation.

Further, since it is possible to largely reduce thermal conduction from the fuel reformer to the base and the lid, it becomes possible to effectively restrain the temperature of the surface of an external wall of the fuel reformer housing container from rising. As a result, it is possible to effectively prevent that other components in mobile equipment are broken and a user of the mobile equipment is burnt.

Furthermore, forming part of the fuel reformer with the plate-shaped member makes it possible to join the supply pipe and the discharge pipe to the plate-shaped member in an extremely fine condition, and joining the rest part of the fuel reformer to the plate-shaped member by the anodic bonding method makes it possible to easily produce a fuel reformer having high junction reliability.

According to the invention, the absolute value of a difference in thermal expansion coefficients between the plate-shaped member and the rest part of the fuel reformer is 20×10⁻⁶/° C. or less. Therefore, it is possible to make stress due to the difference in thermal expansion coefficients between the plate-shaped member and the rest part of the fuel reformer to be sufficiently small, to a repetition of ordinary temperature and operation temperature of the fuel reformer, after the plate-shaped member and the rest part of the fuel reformer are joined by anodic bonding. As a result, it becomes possible to effectively restrain occurrence of a crack or the like in the fuel reformer, and obtain excellent junction reliability.

According to the invention, it is possible to safely discharge gas such as hydrogen gas obtained by reforming in the fuel reformer to the outside of the fuel reforming apparatus and make power generation loss small.

According to the invention, the fuel reforming apparatus comprises a fuel reformer for generating reformed gas including hydrogen gas from fuel; a base that has on one surface thereof a concave portion for housing the fuel reformer therein; a lid attached to the one surface of the base so as to cover the concave portion; and a pipe-shaped member whose central portion is parallel to a bottom surface of the concave portion in a space between the lid and the bottom surface of the concave portion and both end portions pierce the base or the lid, respectively, and in which fuel is supplied from one of the end portions and the reformed gas is discharged from the other end portion, wherein the pipe-shaped member is cut and removed in parallel to an axial direction at an upper side of the central portion and forms part of the fuel reformer, and the fuel reformer is composed so that a rest part of the fuel reformer is joined, preferably by anodic bonding, onto a lower side of the central portion of the pipe-shaped member. Therefore, it is not necessary to directly join the whole rear surface of the fuel reformer to the inside of the base and the lid by surface junction, or join via a pedestal or the like, and it is possible to effectively restrain heat of the fuel reformer from being conducted to the base and the lid. As a result, it is possible to thermally insulate the fuel reformer and restrain the temperature of the fuel reformer from decreasing, it is not necessary to keep supplying a large amount of electric power to a heater for maintaining a temperature necessary for favorably operating the fuel reformer, and it is possible to outstandingly increase the efficiency of power generation.

Further, since it is possible to largely reduce thermal conduction from the fuel reformer to the base and the lid, it becomes possible to effectively restrain the temperature of the surface of an external wall of the fuel reformer housing container from rising. As a result, it is possible to effectively prevent that other components in mobile equipment are broken and a user of the mobile equipment is burnt.

Furthermore, it is possible to effectively prevent the junction failure by forming part of the fuel reformer with the pipe-shaped member that is integrated with the supply pipe and the discharge pipe. Besides, joining the rest part of the fuel reformer to the pipe-shaped member by the anodic bonding method makes it possible to easily produce a fuel reformer having high junction reliability, and it becomes possible to extremely easily compose a fuel reforming system in which a fuel supply portion and a reformed gas discharging portion are built.

Still further, since part of the fuel reformer has a pipe-shaped structure, it is possible to reduce the volume of the fuel reformer. In other words, the conventional fuel reformer is composed by forming a fluid channel to become a reaction bath on a silicon plate or the like and joining a glass plate or the like to the silicon plate as a cover so as to cover the groove, and heat is conducted to the whole glass plate, and therefore, a large amount of heat is required to maintain the temperature of the fuel reformer. On the other hand, in the invention, part of the fuel reformer is formed by not the glass plate but the pipe-shaped member that only covers the fluid channel, and therefore, it is possible to reduce the volume of the cover and keep the temperature of the fuel reformer high with a smaller amount of heat. As a result, it is possible to further increase the efficiency of power generation.

Further, since part of the fuel reformer has a pipe-shaped structure, the joining area of an anodic bonding portion of the pipe-shaped member and the rest part of the fuel reformer becomes small, and it becomes possible to reduce junction stress of the anodic bonding portion, so that it is possible to obtain high junction reliability.

According to the invention, the absolute value of a difference in thermal expansion coefficients between the pipe-shaped member and the rest part of the fuel reformer is 20×10⁻⁶/° C. or less. Therefore, it is possible to make stress due to the difference in thermal expansion coefficients between the pipe-shaped member and the rest part of the fuel reformer to be sufficiently small, to a repetition of ordinary temperature and operation temperature of the fuel reformer, after the pipe-shaped member and the rest part of the fuel reformer are joined by anodic bonding, and it becomes possible to effectively restrain occurrence of a crack or the like in the fuel reformer, and obtain excellent junction reliability.

According to the invention, it is possible to safely discharge gas such as hydrogen gas obtained by reforming in the fuel reformer to the outside of the fuel reforming apparatus and make power generation loss small.

### BRIEF DESCRIPTION OF THE DRAWINGS

Other and further objects, features, and advantages of the invention will be more explicit from the following detailed description taken with reference to the drawings wherein:

FIG. 1 is a cross sectional view showing a fuel reforming apparatus according to a first embodiment of the invention;

FIG. 2 is a cross sectional view showing a fuel reforming apparatus according to a second embodiment of the invention;

FIG. 3 is a cross sectional view showing a fuel reforming apparatus according to a third embodiment of the invention;

FIG. 4 is a cross sectional view showing a fuel reforming apparatus according to a fourth embodiment of the invention.

### DETAILED DESCRIPTION

Now referring to the drawings, preferred embodiments of the invention are described below.

Embodiments of a fuel reformer housing container and a fuel reforming apparatus of the invention will be described below in detail.

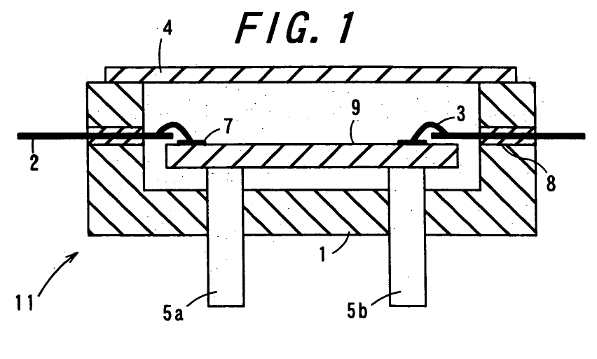

FIG. 1 is a cross sectional view showing a fuel reforming apparatus according to a first embodiment of the invention. A fuel reforming apparatus includes a base 1, a lead terminal 2 serving as a wire, a bonding wire 3, a lid 4, a supply pipe 5a serving as a supplying passage for supplying fuel, a discharge pipe 5b serving as a discharging passage for discharging reformed gas, an electrode 7, an insulation sealing member 8 for sealing and fixing the lead terminal 2 in a through hole of the base 1 in an insulated state, and a fuel reformer 9. A fuel reformer housing container for housing the fuel reformer 9 is mainly composed of the base 1, the lid 4, the supply pipe 5a and the discharge pipe 5b.

The fuel reformer 9 generates reformed gas including hydrogen gas from fuel. The base 1 has on an upper surface as one surface thereof a concave portion for housing the fuel reformer 9 therein. The lid 4 is attached to the upper surface of the base 1 to cover the concave portion. The supply pipe 5a is for supplying the fuel to the fuel reformer 9. The supply pipe 5a pierces at least one of the base 1 and the lid 4 (in the embodiment, the base 1) so that a front end thereof is joined to the fuel reformer 9. Further, the supply pipe 5a holds the fuel reformer 9 in a space between the lid 4 and a bottom surface of the concave portion. The discharge pipe 5b is for discharging the reformed gas. The discharge pipe 5b pierces at least one of the base 1 and the lid 4 (in the embodiment, the base 1) so that a front end thereof is joined to the fuel reformer 9. Further, the discharge pipe 5b holds the fuel reformer 9 in a space between the lid 4 and the bottom surface of the concave portion. That is, The supply pipe 5a and the discharge pipe 5b are provided so that the front ends thereof protrude from the bottom surface of the concave portion of the base 1, and arrange the fuel reformer 9 in the space between the lid 4 and the bottom surface of the concave portion of the base 1, in a state where the fuel reformer 9 is away from the bottom surface of the concave portion of the base 1 and a surface of the lid 4 facing the concave portion.

Both the base 1 and the lid 4 in the invention have a role as a container that houses the fuel reformer 9. They are made of, for example, a metallic material such as an Fe alloy, oxygen free copper and stainless steel, a ceramic material such as aluminum oxide (Al₂O₃) sintered body, mullite (3Al₂O₃.2SiO₂) sintered body, silicon carbide (SiC) sintered body, aluminum nitride (AlN) sintered body, silicon nitride (Si₃N₄) sintered body and glass ceramics, or a resin material having high heat resistance such as polyimide.

Glass ceramics applicable to the base 1 and the lid 4 is composed of a glass component and a filler component. The glass component is, for example, SiO₂—B₂O₃, SiO₂—B₂O₃—Al₂O₃, SiO₂—B₂O₃—Al₂O₃-MO (M represents Ca, Sr, Mg, Ba or Zn), SiO₂—Al₂O₃-M¹O-M²O (M¹ and M² are the same or different, and represent Ca, Sr, Mg, Ba or Zn), SiO₂—B₂O₃—Al₂O₃-M¹O-M²O(M¹ and M² are as described above), SiO₂—B₂O₃-M³₂O (M³ represents Li, Na or K), SiO₂—B₂O₃—Al₂O₃-M³₂O (M³ is as described above), Pb glass, and Bi glass.

Further, the filler component is, for example, a composite oxide of Al₂O₃, SiO₂, ZrO₂ and an alkaline earth metal oxide, a composite oxide of TiO₂ and an alkaline earth metal oxide, and a composite oxide (for example, spinel, mullite, and cordierite) containing at least one selected from the group consisting of Al₂O₃ and SiO₂.

On one hand, in a case where the base 1 and the lid 4 are made of a compact aluminum oxide sintered body whose relative density is 95% or more, the base 1 and the lid 4 are fabricated as follows. For example, a sintering aid such as rare-earth oxide powder and aluminum oxide powder is added and mixed into aluminum oxide powder at first, whereby powder of a raw material of aluminum oxide sintered body is prepared. Next, an organic binder and a dispersion medium are added and mixed into the powder of the raw material so as to become paste and the paste is processed by a doctor blade method, or the organic binder is added into the powder of the raw material and a mixture thereof is processed by press molding, rolling molding or the like, whereby a green sheet having a predetermined thickness is produced. Then, a predetermined number of sheet-shaped products are aligned, laminated and bonded by pressure, and thereafter, the laminated product is baked, for example, at baking maximum temperatures of 1200 to 1500° C. in a non-oxidative atmosphere. In this way, the base 1 and the lid 4 made of ceramic are obtained as aimed. The base 1 and the lid 4 may be formed by a powder mold pressing method.

On the other hand, in a case where the base 1 and the lid 4 are made of a metallic material, they are formed into predetermined shapes by a cutting method, a pressing method, an MIM (metal injection mold) method or the like.

Further, in a case where the base 1 and the lid 4 are made of a metallic material, in order to prevent corrosion, it is desired that the surfaces thereof are subjected to, for example, plating treatment with Au or Ni, or coating treatment such as resin coating with polyimide or the like. For example, in the case of Au plating treatment, it is desired that the thickness is approximately 0.1 to 5 μm.

Further, by covering at least an inner surface of the fuel reformer housing container 11 composed of the base 1 and the lid 4 with a plating treatment film of Au or Al, it is possible to efficiently prevent radiant heat emitted by the housed fuel reformer 9, and it becomes possible to restrain increase of the temperature of the fuel reformer housing container 11.

The base 1 and the lid 4 as described above should be thin in thickness so that the fuel reformer housing container 11 can become small in size and low in height, and it is preferred that bending strength, which is mechanical strength, is 200 Mpa or more.

Next, it is preferred that the lead terminal 2 of the invention is made of metal whose thermal expansion coefficient is equal or approximate to those of the base and the lid 4. When the lead terminal is made of, for example, an Fe—Ni alloy or an Fe—Ni—Co alloy, it is capable of preventing occurrence of thermal strain to a temperature change in practical implementation. Besides, it is capable of exhibiting a favorable sealing adhesion property between the lead terminal 2 and the base 1, and excellent in bonding property, so that necessary strength for mounting and a favorable soldering property and welding property can be secured.

Further, the insulation sealing member 8 of the invention is made of, for example, a glass material such as borosilicate glass, alkali glass and insulation glass whose principal ingredient is lead, or a ceramic material such as aluminum oxide, and the base 1 and the lead terminal 2 are electrically insulated by the insulation sealing member 8 in a through hole formed in the base 1, and the lead terminal 2 is sealed and fixed. The through hole that is formed in the base 1 and where the lead terminal 2 is inserted needs to have a size such that the base 1 and the lead 2 do not come in contact to be electrically conducted, in specific, needs to have an inner diameter such that an interval between the lead terminal 2 and the base 1 of 0.1 mm or more can be secured.

The insulation sealing member 8 may be made of, for example, an insulation member such as ceramics like aluminum oxide sintered body and glass. In this case, for example, by inserting the insulation sealing member 8 having a tubular shape into the through hole formed in the base 1, and further inserting the lead terminal 2 into the insulation sealing member 8, it is possible to electrically insulate the base 1 and the lead terminal 2. When joining the insulation sealing member 8 to the base 1 and joining the insulation sealing member 8 to the lead terminal 2, it is possible to use a brazing material such as an Au—Ge alloy and an Ag—Cu alloy.

The electrode 7 on the fuel reformer 9 and the lead terminal 2 are electrically connected via the bonding wire 3. Furthermore, a concave portion of the base 1 is sealed by the lid 4, whereby a fuel reforming apparatus that the fuel reformer 9 housed in the concave portion of the fuel reformer housing container 11 is hermetically sealed is formed.

Further, the fuel reformer 9 housed in the fuel reformer housing container 11 of the invention is formed as follows. By applying a semiconductor production technique, a liquid fluid channel is produced, for example, by forming a thin groove on a substrate made of an inorganic material such as semiconductor like silicon, silica, glass and ceramics by means of a cutting method, an etching method, a blast method or the like. A cover such as a glass plate is closely attached to a principal surface of the substrate in which the liquid fluid channel is produced by anodic bonding brazing or the like for the purpose of prevention of evaporation of a fluid in operation. In such a state, the fuel reformer 9 is used as a minute chemical device.

Further, inside the fuel reformer 9, a temperature adjusting mechanism such as a thin film heater (not shown) formed by a resistance layer or the like is formed, and on the surface, the electrode 7 is formed as a terminal that supplies electric power to the thin film heater. With the temperature adjusting mechanism, the temperature of the fuel reformer 9 is adjusted to approximately 200 to 800° C. as a temperature condition that corresponds to a fuel reforming condition. Consequently, it is possible to favorably accelerate a reforming reaction of bonding fuel supplied from a fuel supply opening to which the supply pipe 5a is connected, to steam and generating hydrogen gas from the discharge pipe 5b connected to a fuel discharge opening.

The fuel reformer 9 is housed in the fuel reformer housing container 11 so that the lid 4 is attached to the base 1 to cover the concave portion by junction with a metallic brazing material such as an Au alloy, an Ag alloy and an Al alloy or a glass material, a seam weld method or the like.

For example, joining with an Au—Sn brazing material is made as follows. That is, the Au—Sn brazing material is welded to the lid 4 in advance, or the Au—Sn brazing material formed into a frame-shape by punching processing or the like by the use of a die or the like is placed between the base 1 and the lid 4, and thereafter, the lid 4 to the base 1 is joined in a sealing furnace or a seam welder. Consequently, it is possible to seal the fuel reformer 9 in the fuel reformer housing container 11.

In order to further increase heat insulation property inside the fuel reformer housing container 11, it is effective to vaccumize the inside of the fuel reformer housing container 11. This can be achieved by sealing with a brazing material in a vacuum furnace or by a seam weld method in a vacuum chamber at the time of sealing the fuel reformer 9 therein.

Further, the fuel reformer 9 is formed so that the electrode 7 on the fuel reformer 9 is electrically connected to the lead terminal 2 disposed to the base 1 via the bonding wire 3. Consequently, it is possible to heat the heater formed on the fuel reformer 9 through the electrode 7. As a result, it becomes possible to maintain a reaction temperature in the fuel reformer 9, and it is possible to stabilize a reforming reaction of fuel.

The supply pipe 5a and the discharge pipe 5b are a supplying passage of a raw material and a fuel gas fluid and a discharging passage of reformed gas containing hydrogen, respectively. They are made of, for example, a metallic material such as an Fe—Ni alloy, an Fe—Ni—Co alloy and stainless steel, a ceramic material such as Al₂O₃ sintered body, 3Al₂O₃.2SiO₂ sintered body, SiC sintered body, AlN sintered body, Si₃N₄ sintered body and glass ceramic sintered body, a resin material having high heat resistance such as polyimide, or glass.

It is preferred that they are made of a material hard to be embrittled by hydrogen contained in reformed gas. Such a material is an Fe alloy, ceramics, and glass.

Further, it is preferred that the thermal conductivities of the supply pipe 5a and the discharge pipe 5b are 120 W/m·K or less. Consequently, it is possible to more effectively reduce heat conducted from the fuel reformer 9 to the base 1 and the lid 4 via the supply pipe 5a and the discharge pipe 5b, and it is possible to more effectively restrain the temperature of the fuel reformer 9 from decreasing and restrain the temperature of the fuel reformer housing container 11 from increasing.

Further, it is preferred that the opening area of the discharge pipe 5b is larger than the opening area of a discharge hole of the fuel reformer 9. Consequently, it is possible to make the resistance of a flow of reformed gas from the fuel reformer 9 to the discharge pipe 5b to be small, and it is possible to smooth discharge of reformed gas from the fuel reformer 9 and largely increase fuel reforming efficiency.

In concrete, it is preferred that an absolute value of a difference between the opening area of the discharge pipe 5b and the opening area of the discharge hole of the fuel reformer 9 is 350 mm² or less. Consequently, it is possible to effectively restrain stress from being caused by thermal expansion or the like at a joining portion of the discharge pipe 5b and the fuel reformer 9, and favorably maintain the joining strength of the joining portion, and it is possible to further increase the efficiency of discharge of reformed gas.

Furthermore, it is preferred that the supply pipe 5a and the discharge pipe 5b are formed so that the cross sections of joining portions to the fuel reformer 9 and the cross sections of joining portions to the base 1 or the lid 4 are smaller than the cross sections of regions between the joining portions. Consequently, it is possible to favorably maintain the joining strength of the supply pipe 5a and the discharge pipe 5b to the fuel reformer 9 and the joining strength of the supply pipe 5a and the discharge pipe 5b to the base 1 or the lid 4, and more effectively restrain heat from the fuel reformer 9 from being conducted to the base 1 and the lid 4.

Further, it becomes possible to moderately transform the supply pipe 5a and the discharge pipe 5b in the regions having small cross sections. Therefore, in a case where stress due to a difference in thermal expansion coefficients is caused among the supply pipe 5a, the discharge pipe 5b, the fuel reformer 9, the base 1 and the lid 4, or in a case where a shock from outside or the like is applied to the fuel reformer housing container 11, it is possible to relieve the stress by a moderate transformation of the supply pipe 5a and the discharge pipe 5b, and it is possible to favorably maintain junction of the joining portions of the supply pipe 5a and the discharge pipe 5b to the fuel reformer 9 and junction of the joining portions of the supply pipe 5a and the discharge pipe 5b to the base 1 or the lid 4.

Then, the supply pipe 5a and the discharge pipe 5b are inserted into through holes formed in the base 1 or the lid 4. Otherwise, the end surfaces of the supply pipe 5a and the discharge pipe 5b may be joined to the peripheries of the through holes inside the base 1 so as to communicate with the through holes, respectively, and other pipe members may be joined to the peripheries of the through holes outside the base 1 so as to communicate with the through holes, respectively.

For joining the base 1 to the supply pipe 5a and joining the base 1 to the discharge pipe 5b, various sorts of methods including ultrasonic junction, heat welding, pressure bonding, adhesion with a resin adhesive, junction with a brazing material such as Au—Si and Ag—Cu, junction with glass such as borosilicate glass, and simultaneous sintering are properly used according to materials forming the supply pipe 5a, the discharge pipe 5b and the base 1.

Further, it is preferred that the supply pipe 5a and the discharge pipe 5b have inner diameters of 0.1 mm or more so as to restrain pressure loss of a fluid and of 5 mm or less so as to be small in size and low in height.

The cross sections of the joining portions of the supply pipe 5a and the discharge pipe 5b may be circular normally, but not limited. In other words, they can be oval, and polygonal such that sides thereof can be aligned with a flowing direction of a fluid, for example, square and rectangular, other than circular. Moreover, the wall thickness thereof needs to be thick enough to avoid transformation by pressure due to supply of a raw material and discharge of reaction gas. In a case where the supply pipe and the discharge pipe are made of the metallic material such as an Fe—Ni alloy, an Fe—Ni—Co alloy and stainless steel, when used in mobile equipment or the like, a thickness of 0.1 mm or more is sufficient normally. Furthermore, the longer a length in the flowing direction is, the better it is for making it hard to conduct heat generated in the fuel reformer 9 to a power generation cell, but the length should be a length considering the size of the whole fuel cell system.

Further, it is preferred that the supply pipe 5a and the discharge pipe 5b have a plurality of grooves parallel to an axial direction or a plurality of grooves perpendicular to the axial direction formed on the outer surfaces in regions inside the fuel reformer housing container 11. Consequently, it is possible to reduce heat conduction of the supply pipe 5a and the discharge pipe 5b and to more effectively restrain heat conduction from the fuel reformer 9 to the base 1 and the lid 4, and to make the supply pipe 5a and the discharge pipe 5b transform moderately. Therefore, it is possible to relieve stress by moderate transformation of the supply pipe 5a and the discharge pipe 5b, and it is possible to favorably maintain junction of the joining portions of the supply pipe 5a and the discharge pipe 5b to the fuel reformer 9 and junction of the joining portions of the supply pipe 5a and the discharge pipe 5b to the base 1 or the lid 4.

Further, in order to connect the fuel supply opening and the fuel discharge opening of the fuel reformer 9 to the supply pipe 5a and the discharge pipe 5b, a connection method using an inorganic adhesive containing glass such as silica glass and borosilicate glass, various sorts of ceramics and an inorganic polymer, an adhesive containing an organic material having a high heat resistance such as polyimide amide, an organic silicide such as silicone rubber and silicone, various sorts of brazing materials such as an Au—Sn alloy, an Au—Si alloy, an Au—Ge alloy and an Ag—Cu alloy, and a connection method by anodic bonding without using a joining material can be applied. Consequently, a hermetically sealed fuel reforming apparatus is realized.

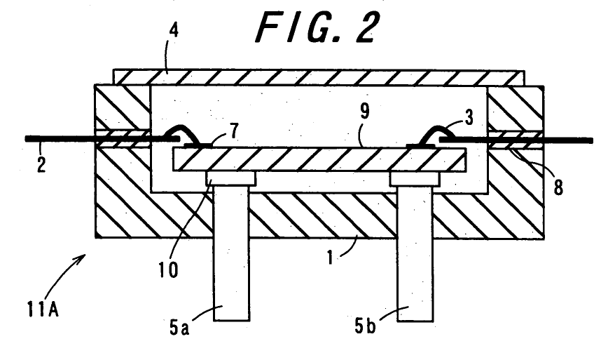

FIG. 2 is a cross sectional view showing a fuel reforming apparatus according to a second embodiment of the invention. In the embodiment, the same components as those of the aforementioned embodiment will be denoted by the same reference numerals. A fuel reforming apparatus includes the base 1, the lead terminal serving 2, the bonding wire 3, the lid 4, the supply pipe 5a, the discharge pipe 5b, the electrode 7, the insulation sealing member 8, the fuel reformer 9, and a member.

A fuel reformer housing container 11A and the fuel reforming apparatus according to the embodiment is similar to the fuel reformer housing container 11 and the fuel reforming apparatus according to the first embodiment, it should be noted that the supply pipe 5a and the discharge pipe 5b are joined, preferably by anodic bonding, to the fuel reformer 9 via the members 10 that are joined to the front ends thereof with a joining material and have larger outer diameters than the supply pipe 5a and the discharge pipe 5b. The description of the components denoting the same reference numerals as those of the aforementioned embodiment will be omitted.

The member 10 is made of, for example, a metallic material such as an Fe—Ni alloy, an Fe—Ni—Co alloy, stainless steel and silicon, a ceramic material such as Al₂O₃ sintered body, 3Al₂O₃.2SiO₂ sintered body, SiC sintered body, AlN sintered body, Si₃N₄ sintered body and glass ceramic sintered body, a resin material having high heat resistance such as polyimide, or glass, and it is preferred that the member 10 is made of the same material as the supply pipe 5a and the discharge pipe 5b.

It is preferred that the outer diameter of the member 10 is twice or more the outer diameters of the supply pipe 5a and the discharge pipe 5b. Consequently, it is possible to join the fuel reformer 9 to the supply pipe 5a and the discharge pipe 5b via the member 10 with high joining strength. Moreover, it is possible to form large joining material menisci from the supply pipe 5a and the discharge pipe 5b to a principal surface of the member 10 around the joining portions of the supply pipe 5a and the discharge pipe 5b to the member 10. By the large joining material menisci, it is possible to increase the joining strength of the member 10 to the supply pipe 5a and the discharge pipe 5b, and it is possible to effectively relieve stress resulting from a difference in thermal expansion coefficients among the fuel reformer 9, the member 10, the supply pipe 5a and the discharge pipe 5b and stress resulting from vibrations caused by supply of fuel, discharge of reformed gas or the like and a shock from outside. Consequently, it is possible to make reliability in junction of the fuel reformer 9 to the supply pipe 5a and the discharge pipe 5b high considerably.

Furthermore, it is preferred that the thickness of the member 10 is 0.01 to 10 mm. Consequently, it is possible to, at the time of joining the member 10 to the fuel reformer 9 by anodic bonding, restrain transformation of the member 10 and favorably join, and it is possible to effectively reduce the amount of heat conducted from the fuel reformer 9 to the member 10, thereby increasing the efficiency of power generation.

Further, it is preferred that the absolute value of a difference in thermal expansion coefficients between the member 10 and the fuel reformer 9 is 20×10⁻⁶/° C. or less. Consequently, it is possible to make stress due to the difference in thermal expansion coefficients between the member 10 and the fuel reformer 9 small sufficiently with respect to a repetition of ordinary temperature and operation temperature of the fuel reformer 9, after the member 10 and the fuel reformer 9 are joined by anodic bonding, and it becomes possible to effectively restrain occurrence of a crack or the like in the fuel reformer 9 and obtain excellent junction reliability.

In a case where the absolute value of a difference in thermal expansion coefficients between the member 10 and the fuel reformer 9 is more than 20×10⁻⁶/° C., a microcrack is easily caused by junction stress caused when the fuel reformer 9 and the member 10 are joined by anodic bonding.

Further, as a joining material for joining the member 10 to the supply pipe 5a and the discharge pipe 5b, an inorganic adhesive containing glass such as silica glass and borosilicate glass, various sorts of ceramics, and an inorganic polymer, an adhesive containing an organic material having high heat resistance such as polyimide amide, an organic silicide such as silicone rubber and silicone, various sorts of brazing materials such as an Au—Sn alloy, an Au—Si alloy, an Au—Ge alloy and an Ag—Cu alloy can be used.

In the embodiment, the supply pipe 5a and the discharge pipe 5b may be joined to the fuel reformer 9 via the members 10 by ultrasonic junction, brazing or welding, instead of anodic bonding.

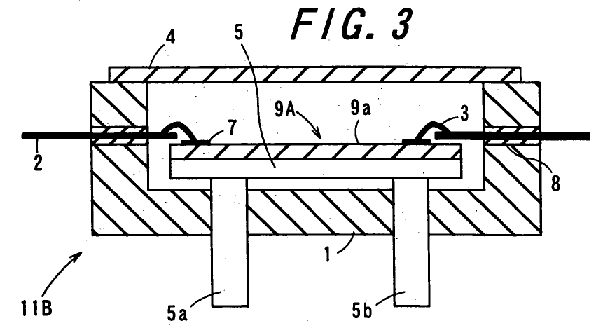

FIG. 3 is a cross sectional view showing a fuel reforming apparatus according to a third embodiment of the invention. In the embodiment, the same components as those of the aforementioned embodiment will be denoted by the same reference numerals. A fuel reforming apparatus of the embodiment includes the base 1, the lead terminal 2, the bonding wire 3, the lid 4, the supply pipe 5a, the discharge pipe 5b, the electrode 7, the insulation sealing member 8, a fuel reformer 9A. A fuel reformer housing container 11B for housing the fuel reformer 9A is mainly composed of the base 1, the lid 4, the supply pipe 5a and the discharge pipe 5b. The description of the components denoting the same reference numerals as those of the aforementioned embodiment will be omitted.

The fuel reformer 9A housed in the fuel reformer housing container 11B of the invention is formed so that a plate-shaped member 5 that is provided with through holes communicating with the supply pipe 5a and the discharge pipe 5b and forms part of the fuel reformer 9A is joined to a rest part 9a of the fuel reformer 9A, preferably by anodic bonding.

The plate-shaped member 5 is made of, for example, a metallic material such as an Fe—Ni alloy, an Fe—Ni—Co alloy and stainless steel, a ceramic material such as Al₂O₃ sintered body, 3Al₂O₃.2SiO₂ sintered body, SiC sintered body, AlN sintered body, Si₃N₄ sintered body and glass ceramic sintered body, a resin material having high heat resistance such as polyimide, or glass, and it is preferred that the plate-shaped member is made of the same material as the supply pipe 5a and the discharge pipe 5b. It is more preferred that the plate-shaped member 5 is formed integrally with the supply pipe 5a and the discharge pipe 5b.

The fuel reformer 9A is formed as follows. By applying a semiconductor production technique, a liquid fluid channel is produced, for example, by forming a thin groove on a substrate which is the rest part 9a of the fuel reformer 9A, made of an inorganic material such as semiconductor like silicon, silica, glass and ceramics by a cutting method, an etching method, a blast method or the like. Then, the plate-shaped member 5 is joined as a cover to a principal surface provided with the liquid fluid channel of the rest part 9a of the fuel reformer 9A for the purpose of prevention of evaporation of a fluid in operation. In such a state, the fuel reformer 9A is used as a minute chemical device.

Further, it is preferred that the absolute value of a difference in thermal expansion coefficients between the plate-shaped member 5 and the rest part 9a of the fuel reformer 9A is 20×10⁻⁶/° C. or less. Consequently, it is possible to make stress due to the difference in thermal expansion coefficients between the plate-shaped member 5 and the rest part 9a of the fuel reformer 9A small sufficiently with respect to a repetition of ordinary temperature and operation temperature of the fuel reformer 9A, after the plate-shaped member 5 and the rest part 9a of the fuel reformer 9A are joined by anodic bonding. As a result, it becomes possible to effectively restrain occurrence of a crack or the like in the fuel reformer 9A and obtain excellent junction reliability.

In a case where the absolute value of a difference in thermal expansion coefficients between the plate-shaped member 5 and the rest part 9a of the fuel reformer 9A is more than 20×10⁻⁶/° C., the rigidity of the fuel reformer 9A becomes insufficient to junction stress caused when the rest part 9a of the fuel reformer 9A and the plate-shaped member 5 are joined by anodic bonding, so that a microcrack is caused easily.

Further, like the fuel reformer 9 according to the aforementioned embodiment, inside the fuel reformer 9A, a temperature adjusting mechanism such as a thin film heater (not shown) formed by a resistance layer or the like is formed, and on the surface, the electrode 7 is formed as a terminal that supplies electric power to the thin film heater. With the temperature adjusting mechanism, the temperature of the fuel reformer 9A is adjusted to approximately 200 to 800° C. as a temperature condition that corresponds to a fuel reforming condition. Consequently, it is possible to favorably accelerate a reforming reaction of bonding fuel supplied from the fuel supply opening of the supply pipe 5a connected to the plate-shaped member 5, to steam, and generating hydrogen gas from the discharge pipe 5b serving as the fuel discharge opening connected to the plate-shaped member 5. The other components of the fuel reformer 9A are the same as those of the fuel reformer 9 according to the aforementioned embodiment, and the description thereof will be omitted.

Further, in the embodiment, the liquid fluid channel is formed on the side of the rest part 9a of the fuel reformer 9A, but it may be formed on the side of the plate-shaped member 5.

In the embodiment, the plate-shaped member 5 may be joined to the rest part 9a of the fuel reformer 9A by ultrasonic junction, brazing or welding, instead of anodic bonding.

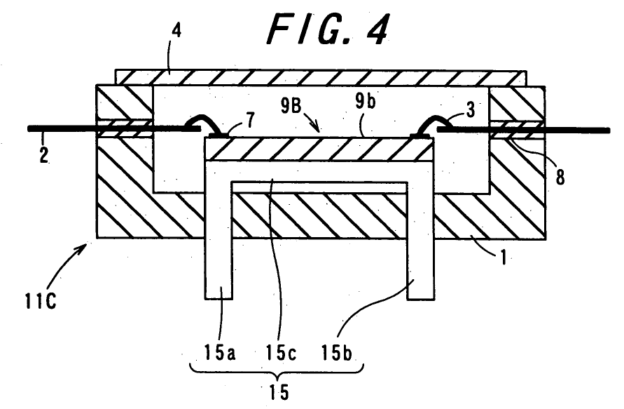

FIG. 4 is a cross sectional view showing a fuel reforming apparatus according to a fourth embodiment of the invention. In the embodiment, the same components as those of the aforementioned embodiment will be denoted by the same reference numerals. A fuel reforming apparatus of the embodiment includes the base 1, the lead terminal 2, the bonding wire 3, the lid 4, a pipe-shaped member 15, the electrode 7, the insulation sealing member 8, a fuel reformer 9B.

The fuel reformer 9B generates reformed gas including hydrogen gas from fuel. The base 1 has on the upper surface as one surface thereof the concave portion for housing the fuel reformer 9B therein. The lid 4 is attached to the upper surface of the base 1 so as to cover the concave portion. As to the pipe-shaped member 15, central portion 15c thereof is parallel to a bottom surface of the concave portion in a space between the lid 4 and the bottom surface of the concave portion and both end portions thereof, that is, a supply pipe portion 15a and a discharge pipe portion 15b pierce the base 1 or the lid 4 (in the embodiment, the base 1), respectively. In this way, in the pipe-shaped portion 15, the fuel is supplied from the supply pipe portion 15a which is one end portion and the reformed gas is discharged from the discharge pipe portion 15b which is the other end portion. A fuel reformer housing container 11C for housing the fuel reformer 9B is mainly composed of the base 1, the lid 4 and the pipe-shaped member 15. Hereinafter, the description of the components denoting the same reference numerals as those of the aforementioned embodiment will be omitted.

The fuel reformer 9B housed in the fuel reformer housing container 11C of the invention is formed so that the pipe-shaped member 15 with an upper side of a central portion 15c cut and removed in parallel to an axial direction is joined to a rest part 9b of the fuel reformer 9B, preferably by anodic bonding.

Further, as mentioned above, the pipe-shaped member 15 is formed so that the central portion 15c is parallel to the bottom surface of a concave portion of the base 1 in a space between the lid 4 and the bottom surface of the concave portion of the base 1, and both end portions thereof, that is, the supply pipe portion 15a and the discharge pipe portion 15b pierce the base 1 or the lid 4, respectively. In this way, fuel is supplied from the supply pipe portion 15a which is one of end portions of the pipe-shaped member 15 and reformed gas is discharged from the discharge pipe portion 15b which is the other end portion.

The pipe-shaped member 15 may be formed so that the supply pipe portion 15a, the discharge pipe 15b and the central portion 15c are integrated. Otherwise, it may be formed so that the supply pipe portion 15a and the central portion 15c are joined and the discharge pipe portion 15b and the central portion 15c are joined.

Further, the central portion 15c of the pipe-shaped member 15 may have a curved shape, for example, like a winding shape to make a reaction path longer for the purpose of making a reforming reaction better.

The pipe-shaped member 15 is made of, for example, a metallic material such as an Fe—Ni alloy, an Fe—Ni—Co alloy and stainless steel, a ceramic material such as Al₂O₃ sintered body, 3Al₂O₃.2SiO₂ sintered body, SiC sintered body, AlN sintered body, Si₃N₄ sintered body and glass ceramic sintered body, a resin material having high heat resistance such as polyimide, or glass.

Further, it is preferred that the central portion 15c of the pipe-shaped member 15 has a radius of curvature of an inner surface of 0.05 mm or more so as to suppress pressure loss of a fluid, and it is preferred that it has the radius of curvature of the inner surface of 2.5 mm or less so as to be small in size and low in height.

The inner surface of the central portion 15c of the pipe-shaped member 15 can normally be a curved surface whose cross section is a hemisphere or the like, but not limited. For example, it may be a polygonal shape whose sides can be aligned with a flowing direction of a fluid. Moreover, the wall thickness needs to be thick enough to avoid transformation by pressure due to supply of a raw material and discharge of reaction gas, and in a case where the pipe-shaped member is made of a metallic material such as an Fe—Ni alloy, an Fe—Ni—Co alloy and stainless steel, when used in mobile equipment or the like, a thickness of 0.1 mm or more is sufficient normally.

Further, the supply pipe portion 15a and the discharge pipe portion 15b are a supplying passage of a raw material and a fuel gas fluid and a discharging passage of reformed gas containing hydrogen, respectively. They are inserted into through holes formed in the base 1 or the lid 4. Otherwise, the end surfaces of the supply pipe portion 15a and the discharge pipe portion 15b may be joined to the peripheries of the through holes inside the base 1 so as to communicate with the through holes, respectively, and other pipe members may be joined to the peripheries of the through holes outside the base 1 so as to communicate with the through holes, respectively.

For joining the base 1 to the supply pipe portion 15a and joining the base 1 to the discharge pipe portion 15b, various sorts of methods including ultrasonic junction, heat welding, pressure bonding, adhesion with a resin adhesive, junction with a brazing material such as Au—Si and Ag—Cu, junction with glass such as borosilicate glass, and simultaneous sintering are properly used according to materials forming the supply pipe portion 15a, the discharge pipe portion 15b and the base 1.

Further, it is preferred that the supply pipe portion 15a and the discharge pipe portion 15b have inner diameters of 0.1 mm or more so as to restrain pressure loss of a fluid and of 5 mm or less so as to be small in size and low in height.

The cross sections of the joining portions of the supply pipe portion 15a and the discharge pipe portion 15b may be circular normally, but not limited. In other words, they can be oval, and polygonal such that sides thereof can be aligned with a flowing direction of a fluid, for example, square and rectangular, other than circular. Moreover, the wall thickness thereof needs to be thick enough to avoid transformation by pressure due to supply of a raw material and discharge of reaction gas. In a case where the supply pipe portion and the discharge pipe portion are made of the metallic material such as an Fe—Ni alloy, an Fe—Ni—Co alloy and stainless steel, when used in mobile equipment or the like, a thickness of 0.1 mm or more is sufficient normally. Furthermore, the longer a length in the flowing direction is, the better it is for making it hard to conduct heat generated in the fuel reformer 9B to a power generation cell, but the length should be a length considering the size of the whole fuel cell system.

The fuel reformer 9B is formed as follows. By applying a semiconductor production technique, a liquid fluid channel is produced, for example, by forming a thin groove on a substrate which is the rest part 9b of the fuel reformer 9B, made of an inorganic material such as semiconductor like silicon, silica, glass and ceramics by a cutting method, an etching method, a blast method or the like. Then, the pipe-shaped member 15 is joined as a cover to a principal surface provided with the liquid fluid channel of the rest part 9b of the fuel reformer 9B for the purpose of prevention of evaporation of a fluid in operation. In such a state, the fuel reformer 9B is used as a minute chemical device.

A liquid fluid channel may not be formed on the side of the rest part 9b of the fuel reformer 9B. In other words, the pipe-shaped member 15 may be the liquid fluid channel, and the rest part 9b of the fuel reformer 9B may be a cover.

Further, it is preferred that the absolute value of a difference in thermal expansion coefficients between the pipe-shaped member 15 and the rest part 9b of the fuel reformer 9B is 20×10⁻⁶/° C. or less. Consequently, it is possible to make stress due to the difference in thermal expansion coefficients between the pipe-shaped member 15 and the rest part 9b of the fuel reformer 9B small sufficiently with respect to a repetition of ordinary temperature and operation temperature of the fuel reformer 9B, after the pipe-shaped member 15 and the rest part 9b of the fuel reformer 9B are joined by anodic bonding. As a result, it becomes possible to effectively restrain occurrence of a crack or the like in the fuel reformer 9B and obtain excellent junction reliability.

In a case where the absolute value of a difference in thermal expansion coefficients between the pipe-shaped member 15 and the rest part 9b of the fuel reformer 9B is more than 20×10⁻⁶/° C., a microcrack is easily caused by junction stress caused when the rest part 9b of the fuel reformer 9B and the pipe-shaped member 15 are joined by anodic bonding.

Further, like the fuel reformer 9 according to the aforementioned embodiment, inside the fuel reformer 9B, a temperature adjusting mechanism such as a thin film heater (not shown) formed by a resistance layer or the like is formed, and on the surface, the electrode 7 is formed as a terminal that supplies electric power to the thin film heater. With the temperature adjusting mechanism, the temperature of the fuel reformer 9B is adjusted to approximately 200 to 800° C. as a temperature condition that corresponds to a fuel reforming condition. Consequently, it is possible to favorably accelerate a reforming reaction of bonding fuel supplied from the supply pipe portion 15a of the pipe-shaped member 15, to steam, and generating hydrogen gas from the discharge pipe portion 15b of the pipe-shaped member 15. The other components of the fuel reformer 9B are the same as those of the fuel reformer 9 according to the aforementioned embodiment, and the description thereof will be omitted.

In the embodiment, the pipe-shaped member 15 may be joined to the rest part 9b of the fuel reformer 9B by ultrasonic junction, brazing or welding, instead of anodic bonding.

The above embodiment does not restrict the invention, and may be changed in various manners within the scope of the invention. For example, in the embodiment shown in FIGS. 1 to 4, the fuel pipe 5a and the discharge pipe 5b or the fuel pipe portion 15a and the discharge pipe portion 15b are joined to the base 1, but they may be joined to the lid 4 according to specifications of the fuel reformer 9, 9A, 9B. Moreover, a plurality of supply pipes 5a and discharge pipes 5b or a plurality of supply pipe portions 15a and discharge pipe portions 15b may be formed.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

1. A fuel reformer housing container comprising:
a base having on one surface thereof a concave portion for housing a fuel reformer for generating reformed gas including hydrogen gas from fuel therein;
a lid attached to the one surface of the base so as to cover the concave portion;
a supply pipe for supplying fuel to the fuel reformer, the supply pipe piercing at least one of the base and the lid so that a front end thereof is joined to the fuel reformer, and holding the fuel reformer in a space between the lid and a bottom surface of the concave portion; and
a discharge pipe for discharging the reformed gas, the discharge pipe piercing at least one of the base and the lid so that a front end thereof is joined to the fuel reformer, and holding the fuel reformer in a space between the lid and the bottom surface of the concave portion.

2. The fuel reformer housing container of claim 1, wherein thermal conductivities of the supply pipe and the discharge pipe are 120 W/m·K or less.

3. The fuel reformer housing container of claim 1, wherein the discharge pipe has an opening area larger than an opening area of a discharge hole of the fuel reformer.

4. The fuel reformer housing container of claim 1, wherein the supply pipe and the discharge pipe are formed so that cross sections of joining portions to the fuel reformer are smaller than cross sections of regions other than the joining portions.

5. The fuel reformer housing container of claim 1, wherein the supply pipe and the discharge pipe are joined to the fuel reformer via members that are joined to the front ends thereof with a joining material and have larger outer diameters than the supply pipe and the discharge pipe.

6. The fuel reformer housing container of claim 5, wherein the supply pipe and the discharge pipe are joined to the fuel reformer via the members by anodic bonding.

7. The fuel reformer housing container of claim 5, wherein thermal conductivities of the supply pipe and the discharge pipe are 120 W/m·K or less.

8. The fuel reformer housing container of claim 5, wherein the discharge pipe has an opening area larger than an opening area of a discharge hole of the fuel reformer.

9. The fuel reformer housing container of claim 5, wherein the supply pipe and the discharge pipe are formed so that cross sections of joining portions to the members and cross sections of joining portions to the fuel reformer are smaller than cross sections of regions other than the respective joining portions.

10. The fuel reformer housing container of claim 5, wherein an absolute value of a difference in thermal expansion coefficients between the member and the fuel reformer is 20×10⁻⁶/° C. or less.

11. A fuel reforming apparatus comprising:
the fuel reformer housing container of claim 1; and
a fuel reformer installed in the concave portion.

12. A fuel reforming apparatus comprising:
a fuel reformer for generating reformed gas including hydrogen gas from fuel;
a base having on one surface thereof a concave portion for housing the fuel reformer therein;
a lid attached to the one surface of the base so as to cover the concave portion;
a supply pipe for supplying fuel to the fuel reformer, the supply pipe piercing at least one of the base and the lid so that a front end thereof is joined to the fuel reformer, and holding the fuel reformer in a space between the lid and a bottom surface of the concave portion; and
a discharge pipe for discharging the reformed gas, the discharge pipe piercing at least one of the base and the lid so that a front end thereof is joined to the fuel reformer, and holding the fuel reformer in a space between the lid and the bottom surface of the concave portion,
wherein the fuel reformer is formed so that a plate-shaped member that is provided with through holes communicating with the supply pipe and the discharge pipe and forms part of the fuel reformer is joined to a rest part of the fuel reformer.

13. The fuel reforming apparatus of claim 12, wherein the plate-shaped member is joined to the rest part of the fuel reformer by anodic bonding.

14. The fuel reforming apparatus of claim 12, wherein an absolute value of a difference in thermal expansion coefficients between the plate-shaped member and the rest part of the fuel reformer is 20×10⁻⁶/° C. or less.

15. A fuel reforming apparatus comprising:
a fuel reformer for generating reformed gas including hydrogen gas from fuel;
a base that has on one surface thereof a concave portion for housing the fuel reformer therein;
a lid attached to the one surface of the base so as to cover the concave portion; and
a pipe-shaped member whose central portion is parallel to a bottom surface of the concave portion in a space between the lid and the bottom surface of the concave portion and both end portions pierce the base or the lid, respectively, and in which fuel is supplied from one of the end portions and the reformed gas is discharged from the other end portion,
wherein the pipe-shaped member is cut and removed in parallel to an axial direction at an upper side of the central portion and forms part of the fuel reformer, and the fuel reformer is composed so that a rest part of the fuel reformer is joined onto a lower side of the central portion of the pipe-shaped member.

16. The fuel reforming apparatus of claim 15, wherein the pipe-shaped member is joined to the rest part of the fuel reformer by anodic bonding.

17. The fuel reforming apparatus of claim 15, wherein an absolute value of a difference in thermal expansion coefficients between the plate-shaped member and the rest part of the fuel reformer is 20×10⁻⁶/° C. or less.
